(19) United States
(12) Patent Application Publication
(10) Pub. No.: US 2002/0196451 A1
(43) Pub. Date: Dec. 26, 2002

(54) System for replicating desired configurations for printers on a network

(75) Inventors: Steven T. Schlonski, Webster, NY (US); Michael G. Leccarde, Penfield, NY (US); Michael H. Wang, Macedon, NY (US); Jeffrey R. Earl, Macedon, NY (US); Lawrence W. Meyer, Fairport, NY (US); M. Kerrigan Hawes, Pittsford, NY (US); Michael C. Burkard, Canandaigua, NY (US); Daniel J. Stark, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/109,800

(22) Filed: Mar. 28, 2002

Related U.S. Application Data
(60) Provisional application No. 60/300,695, filed on Jun. 25, 2001.

(51) Int. Cl. G06F 15/00; B41B 1/00; G06K 1/00; B41J 1/00

(52) U.S. Cl. 358/1.1

(57) ABSTRACT

In a system having a plurality of digital printers on a network, when a newly-installed printer is discovered, new printer's object ID is used to determine the type (make and model) of printer. A template printer, of sufficiently similar type, is also identified on the network. Configuration data is then automatically copied from the template printer to the new printer. A central database of configuration data for various printer types is not required.

### CLAIM OF PRIORITY FROM PROVISIONAL APPLICATION

Priority is hereby claimed from U.S. Provisional Application Serial No. 60/300,695, filed Jun. 25, 2001.

### CROSS-REFERENCE TO RELATED APPLICATION

Cross-reference is here by made to made to co-pending U.S. patent application Ser. No. ______ (Attorney Docket no. D/A1325), entitled “SYSTEM FOR MANAGING DIGITAL PRINTERS AND SERVERS VIA A NETWORK,” assigned to the assignee hereof and being filed simultaneously herewith.

### FIELD OF THE INVENTION

The present invention relates to network management software such as would be used, for example, in a networked printing environment using SNMP (Simple Network Management Protocol). In particular, the invention relates to managing the “configuration” (set of network management instructions) of a large population of printers on a network

### BACKGROUND OF THE INVENTION

Simple Network Management Protocol, or SNMP, is a well-known standard for network management software. A typical application of network management software would be a networked printing environment, wherein there exists on a common network any number of data producers, such as computers, scanners, facsimiles, and the like, as well as one or more output devices, typically digital printers. In more general terms, in a network printing context, the computers, operated by one or more systems administrators, can be considered “managers” while the output devices can be considered “agents,” using the standard terminology of SNMP.

In the SNMP network management terminology, a network management system contains at least one network management station, several managed nodes, each containing an agent, and a protocol which is used by the manager and the agents to exchange management information. A user can obtain data and alter data on the network by using network management software on the manager to communicate with agent software in the managed nodes.

An agent is software running as a background process on each of the target devices, such as a digital printer. When a user requests management data from a device on the network, management software will send an object identification in a management packet or frame to the target agent. The agent interprets the object identifier, retrieves data associated with the object identifier, and sends the data in a packet back to the user. A corresponding process may be invoked to retrieve data.

SNMP defines a structure for a management database (a collection of objects), called the management information base, or MIB. Objects in a MIB have names, called object identifiers (or OIDs), and object types. An object identifier, or OID, is a sequence of non-negative integer values which signify a path through a tree structure of numbered branches (called sub-identifiers, or subtrees). For example, the object identifier 1.3.6.1.4.1.253.2.12 identifies an object found by starting at the root, moving to the branch with the sub-identifier 1, moving to a subordinate branch with the sub-identifier 3, and so forth. In the present example, the branch identified by the first five sub-identifiers, 1.3.6.1.4, is the standard SNMP defined branch called “private.” The next sub-identifier, 1, is for a branch called “enterprises” which is reserved for vendor-specific objects. The next label in the sequence is reserved for specific vendors, each vendor having its own label, such as 253 for Xerox.

In SNMP, information is retrieved from an agent (such as a digital printer) by a manager (such as the PC of a systems administrator) sending a GET or GET-NEXT request with an object identification as a parameter. Data associated with an object can be altered by sending an SNMP SET request to the agent with the object identification as one parameter and the data as another parameter. An object which can be written to is called a “settable” object.

In a practical context of managing a network, or set of subnetworks, having a large population of printers and other office equipment, such as scanners and digital copiers, it would be desirable for a systems administrator to be able to control a plurality of printers of a given type (such as a particular make and model) by sending to the printer a predetermined file of SNMP parameters, which can be called a “configuration,” to the printer, this configuration causing the printer to operate in a desirable way. Each printer on the network of a given type would, preferably in a one-click operation, receive a configuration file instructing the printer to assume a desired configuration. When a new printer of a given type is at one time discovered on the network, such as at installation, it would be desirable to have a largely automatic system by which the type of the newly-discovered printer is determined, and, in response to such determination, a suitable configuration is sent to the printer. Also, it may in some situations be desirable to query a printer on a network as to its configuration, retain that configuration, and then apply that configuration to a printer of similar type that is on the network or which is subsequently discovered on the network.

### DESCRIPTION OF THE PRIOR ART

In the prior art, U.S. Pat. No. 5,367,635 discloses an SNMP-based network management system in which users can add new user defined management objects to an agent. A user editable text file defines object identifications, object types, and the path and name of associated executable software. A user can then invoke user defined executable software at a manage node by sending a network command and a user defined OID to the agent in the manage node.

U.S. Pat. No. 5,580,177 discloses a printer network, including a file server. The file server retains an updated printer driver procedure for each printer type coupled to the file server. The file server is used for updating, as needed, a client processor requesting use of a printer of a certain type.

U.S. Pat. No. 5,638,497 discloses a system for operating a printer network. A workstation user selects a desired printer default configuration, and an address exclusively associated with the selected default configuration is appended to the print data sent from the workstation to the printer.

U.S. Pat. No. 5,692,111 discloses a system for controlling a system of printers and “workstations.” For a printer in the system, configuration information is retrieved from a database retained in a server on the network. The configuration information is transferred from the print server to the workstation, to an extent that allows the workstation to obtain sufficient information for “point and print” operation of a particular printer.

U.S. Pat. No. 5,699,495 discloses a point-and-print capability in a network. Key printer resources, including printer drivers, are retained for use at printers servers that are distributed throughout the environment.

U.S. Pat. No. 5,905,906 discloses a network printing system in which each printer communicates with a host computer. Setup information from a printer is sent, using NPAP messages, and stored in a long-term memory in the host computer and sent to other printers on the network as needed. The printer information is stored in a long-term memory in a host computer.

U.S. Pat. No. 6,026,436, assigned to the assignee hereof, discloses a method for cloning the configuration of one printer to another, by means of a web browser model. A browser is used for obtaining from a first printer an electronic page, and a server provides the electronic page with suitable configuration information. The amended electronic page is then submitted to a second printer.

U.S. Pat. No. 6,119,156 describes a system in which individual OID's, controlling specific hardware and software aspects of a printer, can be selectively locked so that different agents can respectively control different aspects of each printer on a network.

### SUMMARY OF THE INVENTION

According to one aspect of the present invention, there is provided a method of operating a digital printer on a network. A type of the printer is determined. The determined type of the printer is associated with a predetermined configuration. The printer is caused to operate according to the predetermined configuration.

According to another aspect of the present invention, there is provided a method of operating a plurality of printers on a network. At least one new printer is discovered on the network. Data relating to a type of the new printer is obtained from the new printer. A template printer is identified on the network, the template printer being sufficiently of the same type as the new printer. obtaining Configuration data is obtained from the template printer. The configuration data is applied to the new printer.

### BRIEF DESCRIPTION OF THE DRAWINGS

FIG. 1 is a simplified diagram showing the context of the present invention.

FIG. 2 is a flowchart of a network discovery method according to one aspect of the present invention.

FIG. 3 is a flowchart showing an implementation of the present invention.

FIGS. 4-6 are example screen displays incidental to a practical application of the present invention.

### DETAILED DESCRIPTION OF THE INVENTION

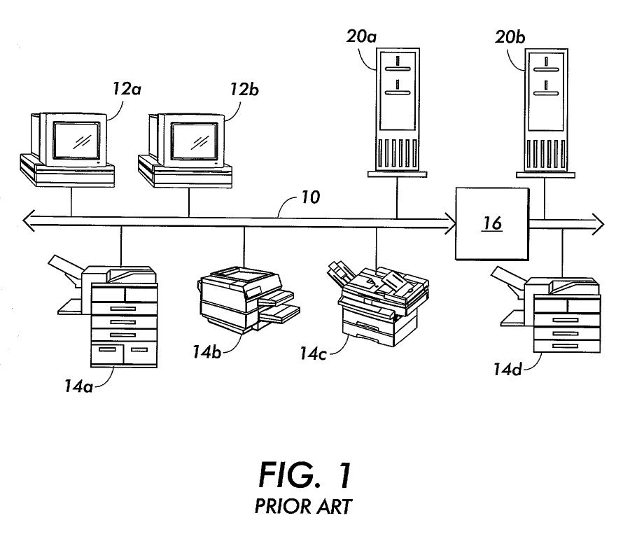

FIG. 1 is a simplified diagram showing the context of the present invention. There is provided a network 10 of a type familiar in the art, such as a network which utilizes the Ethernet® protocol. Existing on this network 10 is at least one computer such as 12a or 12b and, for purposes of the present invention, a plurality of printers, such as here labeled 14a-14c. There is further provided on network 10 what is known as a “router” 16. As is well known in the art, a router such as 16 is capable of discriminating among requests placed on network there 10 connected thereto, so that only specifically-directed requests received by router 16 will be allowed through the router 16, such as to access further printers such as 14d. As is well known, a router 16 serves as to define a “subnetwork” or “subnet” which is separable from any larger network on which the router 16 exists. As is known in the art, in FIG. 1 the set of printers 14a-14c form one subnet, while printer 14d, being on the other side of router 16, can be considered part of another subnet. (For purposes of the present discussion and claims, unless otherwise specified, the words “network” and “subnetwork” or “subnet” can be used interchangeably. Also, the word “printer” can for present purposes mean not only a printer, but any kind of device having printer-like features, such as a multifunction device, digital copier, input scanner, facsimile, etc.)

Computer 12a or 12b in FIG. 1 can be the computer of a systems administrator responsible for the activities of all of the printers on network 10, for example, making sure that a certain number of printers are available for other users on network 10, making sure the printers on network 10 are of particular types, and making sure that the installed printers are functioning. In a real-world context, particularly when there are dozens or even hundreds of printers such as 14a-14c on a network, it is inevitable that printers will be installed and removed from a network 10, or a particular subnetwork, on a fairly regular basis. Further, various installed printers may go offline and return online for various reasons. It is thus not a trivial matter for a system administrator on a computer 12 to have to check what printers are available on a particular network or subnetwork at any given time. Once the various printers are discovered, it is desirable for the system administrator to be able to inspect the web page of any individual printer to make sure that any particular printer is functioning properly. As will be described below, the fact that many of the conditions of an individual printer can be observed or altered through the embedded web page of the printer means that any available function of the printer that is accessible through the web page of the printer can thus be accessed through computer 12.

Also shown in FIG. 1 is a number of servers, which are indicated as 20a, 20b . . . . In a typical practical context, a user at computer 12a will wish to send print jobs only to printers, such as 14a or 14b, which are in physical proximity. Thus, a server such as 20a will provide to computer 12a ready access (such as on a display menu) only to printers 14a or 14b: other printers and servers on the network may not be available to the user of computer 12a, at least not without special permission. Thus, while it may be physically possible for a computer 12a in the United States to send a job to printer 14c in France, the arrangement of servers 20 may intentionally make this difficult, because having all computers potentially accessing all printers may be inefficient.

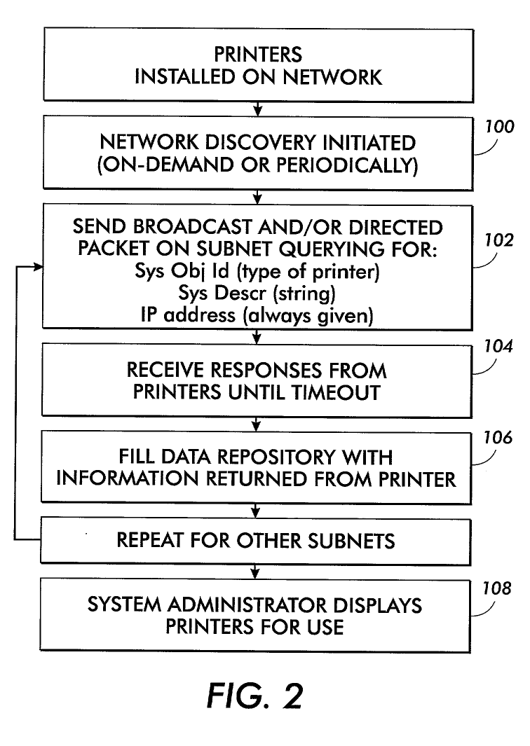

FIG. 2 is a simplified flow chart showing the basic steps of a system in which, first, all of the printers on a network or subnetwork such 10 are discovered, and then information about each individual printer obtained through such discovery process is displayed in a user interface whereby, once the printers on a particular network or subnetwork are identified, the printers are selectable through a simple displayed list. Finally, once the user interface is created and displayed to the system administrator on computer 12, the web site of any particular printer on network 10 can be accessed by the system administrator simply by clicking on a particular internet address or other name on a displayed list. Then, if it is desired to check or alter a condition or function of a particular printer or network 10, this can be carried out directly through the web page of the selected printer.

Various printers will be installed or disinstalled on a particular network at various times. When it is desired to discover all the printers on a network or subnetwork at a particular time, a systems administrator (SA) can cause the computer 12 to send out a packet on a particular subnet (or, of course, on the network 10 itself, if there are no distinct subnets). Alternately, it may be desired to automatically initiate a discovery step (that is, placing of the packet on a particular subnet or network) on a regular basis, such as every 24 hours or on every reboot of the computer 12. This initiation of network discovery is shown as step 100.

At network discovery, a packet is placed on the network 10 and is thus made available to every printer that may be on a particular network or subnet. All printers such as 14a-14c which are compliant to a standard such as RFC-1759 or RFC-1213 will, according to the standard, respond to the packet (descriptions of these standards can be seen at www.ietf.org). The “payload” part of the packet is a request for three distinct types of data. As shown in step 102, the packet requests the system object ID, which is a special code indicating the make and model or type of printer (every manufacturer of printers is assigned a specific code, and then assigns another code to various models it manufactures); a system description, which is a string variable which describes the type of printer in more human-readable terms (e.g., “Xerox DocuPrint N60 printer”); and finally the IP address of the printer in question, which is always provided in a response to a packet.

At step 104, following the placing of the packet on network 10 by computer 12, computer 12 waits for a predetermined period of time, such as 8 seconds, to receive responses from any printers which may be on a particular subnetwork or network 10. The computer 12 thus collects all the responses (system object ID, system description, and IP address) that it receives. This data initially collected from the printers in response to the packet is then used to provide data to what is known as a user interface and allowed to populate the user interface. Then, a list of system descriptions and IP addresses for all of the discovered printers is created.

As further can be seen in step 108, it may be necessary to repeat the above process of placing packets for other subnets of interest to the user of computer 12. As is well known, in order to access distinct subnets within a larger network, it is necessary to know a relevant address associated with the subnet, which would be passed through a router such as 16 in FIG. 1. Additional printers found as new subnets are communicated to can simply be added to an accumulating list of printers in the user interface.

Once all of the desired subnets have experienced the network discovery such as shown as steps 102-106, there will result a user interface in which all of the known printers are listed in the display. In a preferred embodiment of the present invention, this resulting list can be displayed to the systems administrator on computer 12, who in turn can select individual printers listed therein. When the systems administrator (SA) thus selects a printer, the point-and-click action thus causes the selected printer to be accessed over network 10, and the web page of the selected printer to appear in the user interface, as shown at step 110 of FIG. 2. Once the systems administrator thus has access to the web page and embedded web server of the selected printer, the system administrator can access, and as necessary alter, any information available to the system administrator through the web site of the particular printer.

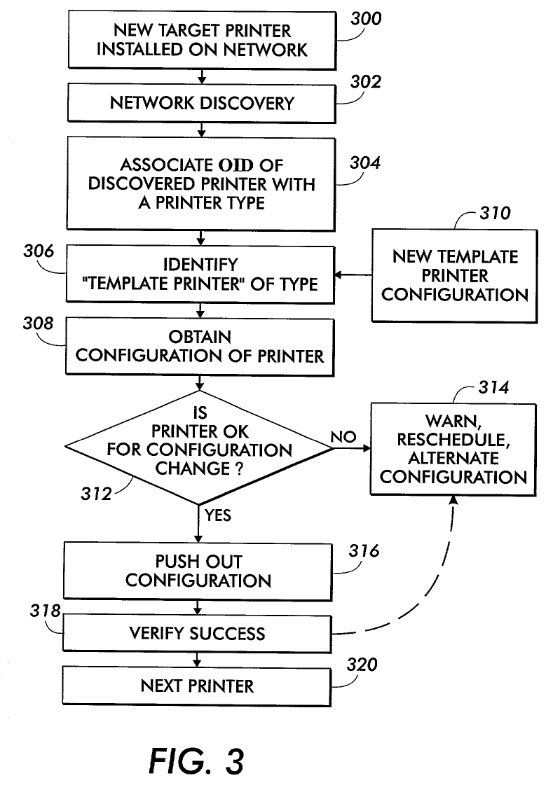

FIG. 3 is a flowchart showing how a configuration suitable for a particular type of printer can be found or otherwise determined and then supplied to a target printer of interest on a network. Step 300 shows a new printer, of as yet unknown type, being installed on the network. In order, to operate on the network, this new printer must receive a suitable set of settings, or in short a “configuration.”

The new printer installed at step 300 is discovered as a result of a discovery process at step 302. The discovery step is generally described above with regard to FIG. 2, and may occur on a regular basis or as deliberately requested by an SA. As described above, one important datum which is received from the new printer is the object ID, which identifies the type of printer which has been installed, such as through an association step which occurs in the SA's computer (step 304). Once the type of printer is known, a desired configuration can be applied to the printer.

According to the illustrated embodiment, there is present on the network what is called a “template printer,” meaning an already-installed printer of a given known type, the current configuration of which is used to apply to any further printer of that type which exists or subsequently appears on the network. This template printer is identified by the SA, such as shown at step 306, via a user interface on his computer, as will be shown below. In this embodiment, the configuration data for a printer of a given type is retained only at the template printer (incidental to the printing functions carried out by the template printer), and is not retained independently, for any appreciable length of time, at the SA's computer or at any server. When configuration data is required, the configuration data is obtained from the template printer, such as at step 308, for sending to the new printer.

When sending configuration data to the new printer, it must first be determined, as described at step 312, that the printer is ready or able to accept a new configuration. There may be various reasons why imposing a new configuration may be impossible. First, in some instances the software mechanism for changing the configuration may be locked for security reasons. In other cases, a printer would be incapable of accepting a new configuration while it is running, although it may be able to accept the new configuration later in time. Step 314 shows that, depending on the reason (if detectable) that the target printer cannot accept a change in configuration, the administrator can be warned, and/or the operation can be rescheduled. Another possibility, according to one aspect of the present invention, is that if sending out a first desired configuration does not work, an alternate configuration can be automatically tried.

After the desired configuration is sent to the printer (step 316), various straightforward tests can be performed to verify the success of the change in configuration (step 318). The system can then be applied to another printer (step 320), either the next printer to be discovered, or as part of a process of updating the configuration of a large number of printers on the network.

A variation of the present method is when the configuration of the template printer is changed, such as at step 310, and the new configuration is desired to be replicated to all other printers of the same type on the network. In such a case, all of the printers of the same type on the network are systematically caused to receive the same configuration as the template printer.

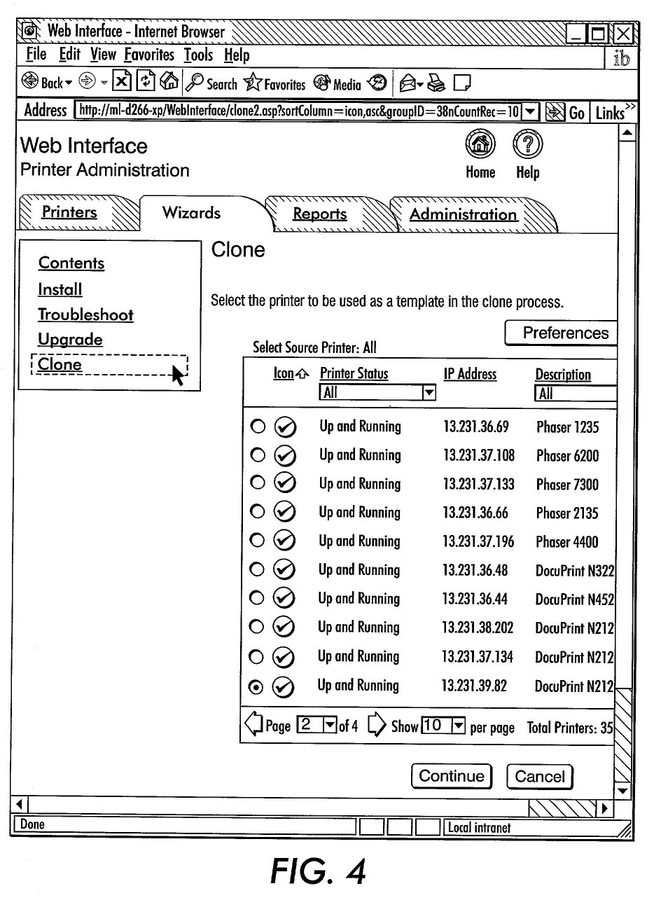

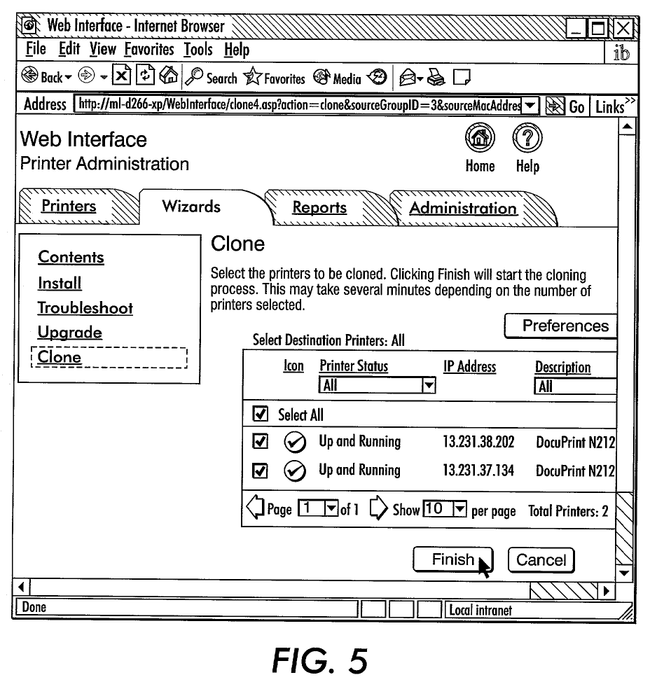

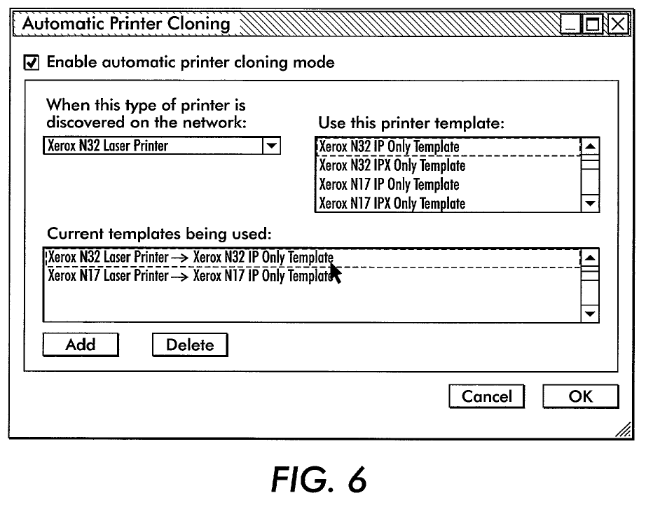

FIGS. 4-6 are example screen displays, as would appear on an SA computer, incidental to a practical application of the present invention. FIG. 4 shows a screen display allowing the SA to select a template printer from those printers known on the network, such as at step 306 as described above: as can be seen, the SA can have the option of selecting one printer of each type to be the template printer for other printers on the network of that type. FIG. 5 is a screen display giving the SA the option of sending the configuration (“cloning”) from a template printer to multiple printers of that type. FIG. 6 is a screen for enabling an “automatic mode,” wherein the SA can lay down rules for identifying a template printer and sending its configuration data in response to the discovery of a new printer of an identified type.

In a practical embodiment of the invention, the steps of obtaining configuration data from a template printer and sending the data to a new printer are initiated by the discovery of a new printer on the network, and occur substantially invisibly to the SA or other user. Alternately, the steps of sending configuration data to printers of a given type on a network can be initiated by a change in configuration of a template printer.

1. A method of operating a digital printer on a network, comprising:
determining a type of the printer;
associating the determined type of the printer with a predetermined configuration; and
instructing the printer to operate according to the predetermined configuration.

2. The method of claim 1, further comprising
obtaining data related to the predetermined configuration from a template printer on the network.

3. The method of claim 1, further comprising
discovering the digital printer on the network.

4. The method of claim 1, wherein the determining step includes obtaining an object ID from the printer.

5. The method of claim 4, further comprising associating the obtained object ID from the printer to a predetermined type of printer.

6. The method of claim 1, the instructing step including causing a first printer and a second printer on the network to operate according to the predetermined configuration.

7. A method of operating a plurality of printers on a network, comprising:
discovering at least one new printer on the network;
obtaining from the new printer data relating to a type of the new printer;
identifying a template printer on the network, the template printer being sufficiently of the same type as the new printer;
obtaining configuration data from the template printer; and
applying the configuration data to the new printer.

8. The method of claim 7, wherein the identifying step is a result of the discovering step.

9. The method of claim 7, wherein the obtaining step includes obtaining an object ID from the new printer.

10. The method of claim 7, wherein the configuration data is not retained for an appreciable length of time at a server.
